(19) United States
(12) Patent Application Publication
(10) Pub. No.: US 2024/0418195 A1
(43) Pub. Date: Dec. 19, 2024

(54) Reusable Polymeric Implement

(71) Applicants: Frank V. Patterson, Travelers Rest, SC (US); Tracy L. Yoho, New Fairfield, CT (US)

(72) Inventors: Frank V. Patterson, Travelers Rest, SC (US); Tracy L. Yoho, New Fairfield, CT (US)

(21) Appl. No.: 18/628,549

(22) Filed: Apr. 5, 2024

Related U.S. Application Data
(63) Continuation-in-part of application No. 18/211,223, filed on Jun. 16, 2023.

(51) Int. Cl. F16B 13/08

(52) U.S. Cl. CPC F16B 13/08

(57) ABSTRACT

A reusable thermoplastic object mounting tool that is useful for attaching and manipulating an object in a confined space. The hand tool includes end threads for temporary attachment of an object and a flexible segment having sufficient elasticity to permit bending within this segment to present a folded profile during the installation of the object and recovery from the folded conformation after folding stress is relieved.

### CROSS REFERENCE TO RELATED APPLICATION

This application is a continuation-in-part of U.S. application Ser. No. 18/211,223, filed Jun. 16, 2023, the disclosure of which is hereby incorporated in its entirety by reference thereto.

### FIELD OF THE INVENTION

The present invention relates to a reusable hand tool, formed as a contiguous thermoplastic material, produced by methods such as injection molding. The reusable hand implement is useful for manipulating an attached object in confined areas, such as an object that is being installed through an aperture such as within a hollow wall or hollow ceiling.

### SUMMARY OF THE INVENTION

It is the general object of the present invention to provide a single member, or contiguous thermoplastic reusable hand implement, or hand tool, that may be readily manufactured using conventional injection molding or 3-D printing methods instead of tools heretofore produced from assemblies of multiple metal parts. The implement described herein includes an integrated polymeric flexible segment that acts as a so called “living hinge”, or shape memory element, and thereby can replace metal tools that would require pivot joints or springs to permit bending or folding to angles such as about 90 degrees or such as 180 degrees, but which can advantageously recoil to a lesser angle. The inventive polymeric implement includes terminal threads that engage inner threads of an object to thereby attach and detach an object, such as a mounting plate, sensor, or other confined space installations.

Another object of the invention is to provide a polymeric implement with an incorporated centering disc, in which the centering disc assists an operator with aligning the object when installed through a drilled hollow wall aperture.

Still another object of the invention is to provide an integrated tensioning means which acts as a sort of clamp to hold the implement in place during a time when an adhesive is curing. The implement therefore includes a shaft segment equipped with threads that are engineered to engage a nut or threaded bushing. A nut or threaded bushing may be employed to exert tension along the implement shaft threads. The shaft threads are molded or machined along a shaft segment, between a gripping portion and the flexible portion of the implement.

Another object of the invention is to provide a plastic hand implement useful when installing a fastener that integrates gripping means, attaching means, twisting means, tensioning means, and detaching means into a single tool.

Another object of the is to provide an integrated flexible segment that permits the threaded end to pivot an attached object, recover from a pivot, and thereafter detach from the object for reuse.

Another object of the invention is to provide a method of installing an object into an aperture of a hollow wall aperture using a flexible polymeric hand implement.

Another object of the invention is to provide a hand tool, or hand implement for use when installing and subsequently tensioning an object inserted through a wall aperture of various thicknesses.

These and other advantages are set forth in the disclosure included herein.

### DEFINITIONS

As used herein, the term “hollow wall material” refers to a plurality of construction materials and positions. Hollow wall materials are utilized in a number of construction applications such as structural metal tubing or board-like materials. In the case of board-like materials, such products are typically attached to load bearing or partition members, which result in hollow regions between those members. Those having ordinary skill in the art recognize that hollow wall materials include gypsum “dry wall,” wood panel, composite panel such as carbon fiber or graphite panel, fiberglass panel, marine or automotive panel, concrete panel, hollow metal structural steel, sheet metal, and the like.

Gypsum board, or dry wall, refers to a friable center mineral laminated between two outer layers of paper or film.

The term “wall” herein refers to upper, lower, bottom, top or side positions, and thereby includes ceiling, floor, side wall, decking, automotive, and marine applications. Examples of hollow wall include automotive fenders and boat decks.

As used herein, the term single member mounting tool regards a contiguous polymeric implement useful in mounting objects such as a fastener plate. The mounting tool disclosed herein is formed from a single piece of thermoplastic material rather than prior art multi-part metal mounting implements.

As used herein, the term “reusable” refers to the ability of the polymeric mounting implement to work independently of the object to which it may be threadably attached. This is in contradistinction to certain prior art fasteners that assist with mounting a toggle but are severed after use and thereafter disposed because the implement cannot be reused.

As used herein, the term “recessed” refers to an object or device that resides behind the front plane of the wall material. A recessed device does not include or require any component that projects above the front face of the wall material in order to become self-supporting. Those having ordinary skill in the art recognize, however, that certain objects to be mounted using the recessed devices of the invention may introduce an object component that could reside above the wall plane, however, the addition of a such a front surface object component, such as a bracket, base, or extension collar, is not a part of the mounting devices or implements of the invention.

As used herein, the term “flexible” segment refers to an integrated portion of the injection molded tool that permits bending within that flexible segment so as to permit an object attached to the implement first end to bend within the flexible segment approximately 90 degrees to approximately 180 degrees during end-on insertion of a recessed object through a wall aperture. The flexible segment advantageously possesses elastic recovery which enables the implement to recoil from such bend to permit an attached object to return toward a transverse orientation. In preferred embodiments, the flexible segment is positioned between and is immediately adjacent to the sizing disc and the implement shaft segment. As will be clear to those having ordinary skill in the art, the flexible segment may be engineered with many geometries and lengths relative to other implement segments. The flexible segment is typically the smallest diameter other than the implement end threads. The flexible segment may be configured with several possible geometries and may exhibit more than a single diameter, as for example, a tape shape, a ribbon shape, a cylinder shape, a half-cylinder shape, or an elliptic cylinder shape.

As used herein, the term “tensioning” regards the use of a tool element to exert pressure upon an object attached to the implement, so as to for example, urge the object into firm contact with the rear face of hollow wall material during the adhesive bonding of the object to the rear wall surface.

As used herein, the term sizing disc refers to an element of the hand implement immediately adjacent to the implement first end terminal threads, wherein such disc assists with coaxial alignment of a recessed self-supporting fastener base within a drilled hollow wall aperture. The sizing disc may include rounded or chamfered outer edges to improve passage through, and retrieval of the disc when advancing through and retrieving this segment from a drilled wall or ceiling aperture.

As used herein, the term “gripping end” refers to the hand implement second end portion which enables one to firmly grip the hand implement when installing, aligning, and centering an attached object through a blind hole. The gripping end is also used when twisting the implement, particularly when desiring to unscrew the hand implement from an object threadably attached at the implement terminal end.

As used herein, the term implement shaft, or tool shaft refers to an implement element that exhibits a greater diameter than the diameter or the cross-sectional width of the flexible tool segment, and therefore is comparatively rigid. The tool shaft is equipped with a length of external threads which extend forward to meet the unthreaded flexible segment. Implement shaft threads are engineered to accept and threadably engage a tensioning device such as a nut or threaded bushing. Implement threads or shaft threads may be bounded at either end by a segment of lesser diameter than the external threads. Shaft threads may optionally include flattened and unthreaded portions to provide gripping while still engaging a tensioning nut or bushing.

As used herein, the term “bushing” refers to an implement element that may be used to assist with exerting tension between the front face of a hollow wall or ceiling and a recessed object. The bushing may float freely on the shaft threads and flexible segments of the hand implement and thereby act as a sort of washer in front of a wing nut, or in other embodiments, the bushing may be integrated into a single accessory in the case of a single injection molded bushing having inner threads. The fully integrated threaded bushing would directly engage tool shaft threads. Such an injection molded threaded bushing would typically be produced from polyamide, polyester, or polyolefin.

As used herein, the term polyolefin refers to thermoplastic polymers including high density polyethylene (HDPE), linear low density polyethylene (LLDPE), homopolypropylene (PP), propylene copolymers, and propylene/ethylene copolymers (P/E).

### BRIEF DESCRIPTION OF THE DRAWINGS

Having thus generally described the nature of the invention, reference will now be made to the accompanying drawings.

FIG. 1 is a perspective diagram illustrating one possible geometry of the self-supporting back mounting plate component in accordance with an embodiment of the present invention;

FIG. 2 illustrates a self-supporting back plate prior to bonding to the rear face of wall board with threaded insert installed within the primary bore, a monofilament grasping means, and wherein the back plate is divided by the primary plate bore into first and second curved segments;

FIG. 3 is an exploded view of an embodiment of the invention illustrating use of a plate equipped with a channel along one segment of the inner surface to nest a pivoting grasping means and the plate equipped with a threaded pivoting dowel;

FIG. 4 depicts perspective diagrams according to other embodiments of the present invention depicting a metal hand tool grasping means and plate securing means useful in carrying out the invention;

FIG. 4A is a perspective exploded diagram of a longitudinally truncated cylinder back plate adapted to engage a grasping tool in a twist key manner;

FIG. 4B is a rear view of a back plate having a slot and threaded bore extending through the rear outer surface;

FIG. 4C is a perspective view of exploded diagram of a longitudinally truncated cylinder back plate equipped with female threads within the bore adapted to engage pivoting tool segment with terminal male threads;

FIG. 5 is a perspective view of a back plate embodiment in which the plate is equipped with cylindrical wells on each plate segment to receive a deposit of adhesive;

FIG. 6 is a perspective view of a back plate joined to grasping means, and prepared to couple to a tensioning hand tool;

FIG. 7 is an illustration of a prior art spring-loaded folding toggle device toggle bolt fastener;

FIG. 8 is a schematic view of a prior art split plastic shield insert and mounting screw inserted in a drilled the hole in a wall board;

FIG. 9 is a cross-sectional view of the use of a reducing bushing and back plate depicting the reduction of the thread size of a securing means incorporated into an affixed back plate;

FIG. 10 illustrates of a thermoplastic hand implement according to embodiments of the invention, with flexible segment 1003 depicted as having a ribbon strip, elliptic cylinder, half cylinder, or cylindrical shape; and gripping element 1005 extending into threaded shaft segment 1004. In FIG. 10B the shaft segment includes with longitudinally flattened opposite sides that provide greater surfaces for hand gripping;

FIG. 11 illustrates a cut away view of a hand implement embodiment during the insertion of a mounting plate through a hollow wall aperture. The flexible segment is depicted in its folded conformation;

FIG. 12 illustrates a cut away view of the hand implement being used to insert a mounting plate through a hollow wall aperture after mounting plate has entered the hollow wall portion and the flexible segment has rebounded from a folded conformation;

FIG. 13 illustrates a cut away view of a hand implement embodiment following insertion of an object through a hollow wall aperture and advancing a tensioning nut along the implement threaded shaft to apply force during adhesive curing;

FIG. 14 illustrates a cut away view of a hand implement embodiment during the insertion of mounting plate 500 through a wall aperture. The flexible segment 1403 is depicted in a minor diameter immediately adjacent to a larger diameter shaft portion 1406 as flexible segment 1403 assumes a hook or question mark shape while plate 500 is folded to load end-on through the wall aperture; and

FIG. 15 illustrates a cut away view of a hand implement embodiment useful for manipulating an object threadably attached thereto. Flexible segment 1403 is depicted as recovering from its crook or gooseneck geometry toward a transverse presentation of the attached object, prior to applying tension along threaded shaft segment to urge plate 500 into contact with the rear wall surface during adhesive curing.

### DETAILED DESCRIPTION OF THE INVENTION

The inventive thermoplastic hand implement integrates into one reusable implement: terminal end screw threads, an alignment disc fused to the end threads in a manner similar a plastic pan screw head, a flexible segment, adjacent to the alignment disc, that permits bending along the flexible segment, shaft threads located immediately adjacent to the flexible segment, adapted to engage a tensioning nut or tensioning bushing, and a second end to enhance gripping of the implement when manipulating the implement as it performs it functions. The thermoplastic implement enables one to load an attached object using terminal implement threads, pass the object through a drilled wall aperture, apply tension, and subsequently unscrew an object, so that the hand implement may be used again for another operation. Implements of the invention temporarily attach to objects such as a back plate and readily detach such as when mounting a self-supporting rear mounting plate, in which case the implement is removed after the adhesive has bonded to the rear wall surface and the back plate becomes self-supporting. The tools of the invention be repeatedly used on a range of self-supporting objects equipped with inner mounting threads.

### The Mounting Plate

A variety of self-supporting back plate geometries and plate materials are included within the scope of the invention. Relevant mounting plate materials include metal, thermoplastic polymers, thermoset polymers, and wood. Back plate materials preferably include inner surface modifications to enhance mechanical adhesion to a deposit of adhesive. The wall contact surface of the self-supporting mounting plate includes adaptations such as channels, depressions, pips, wells, crosshatching, chemical etching, laser etching and similar adaptations. Irrespective of the material type, back plate inner surface modifications enhance the retention of an adhesive deposit during the installation of the plate through the wall opening and help retain the adhesive during alignment and pulling the back plate into firm contact with the rear wall face. Back plate inner surface adaptions help retain a deposit of adhesive so as to reduce dripping, in the case of a deposit of a liquid adhesive, during the insertion and bonding to the wall rear face. In preferred embodiments, inner surface adaptions such as wells ensure that an adequate deposit of adhesive is loaded and located outboard of the central bore threads so as to ensure good bonding to the hollow wall rear face without contamination of the coupling between the object threads and the implement end threads. In the case of an injection molded back plate, surface features may be conveniently molded into the inner surface to enhance adhesive acceptance upon the inner surface. For example, engineered surfaces may be molded to meet industry standard, SPI Grade D-3 with a Ra of 3.20 to 18.0 μm. Grade D-3 and other surface adaptations may be attained using drilling, sanding, laser etching, chemical etching, or EDM.

One back plate geometry includes a rectangular contact inner surface whose thickness is substantially less than its length. This quadrilateral bar-like design facilitates end-on insertion through a small wall aperture and provides strong mechanical performance owing to its span after aligning along the wall inside surface. Other contiguous planar back plate geometries conceived herein include “S” shaped, fan-shaped, boomerang shaped, bow-tie shapes, or other contiguous component geometries that extend from a primary bore within the plate. In the case of fan blade or curved geometries, distal elements may be symmetrical or asymmetrical relative to the primary bore. The objective of all single member, or contiguous back plate designs is to deliver maximum surface area along rear wall surface whilst keeping the end-on wall insertion aperture small. The exceptionally strong mounting strength of the inventive back mounting plate overcomes mechanical weaknesses of many prior art wall inserts such as the split component wall anchors. It is useful to provide a plate whose length that is about 4 times to about 12 times greater than the thickness, such as about 4 times to 8 times greater than the plate thickness. Plate length is limited by the cavity depth within the wall and may restrict the plate length from about 3 inches to about 5 inches. In contrast to the plate inner, wall contact surface, the back plate outer, or rear surface may have geometries the same as or different from that of the substantially planar inner surface. For example, the back plate outer surface may be convex or hemispherical to assist with insertion and orientation. For example, the plate outer surface geometry may be a longitudinally truncated cylinder, half cylinder, or turtle back shaped.

### Object Installation

The inventive mounting implement is equipped with first end threads that are engineered to engage central threads of an object to be attached, and a second implement end that provides a segment for hand grip. The second end of the implement includes a substantially flat segment optionally equipped with ridges to enhance the grip when inserting, manipulating, aligning, and detaching the hand implement. In certain embodiments the flattened surfaces may extend beyond the second end to permit one to grip the implement along the rod-like shaft of the implement. In typical use applications, the reusable thermoplastic mounting implement is temporarily attached to the object at the first end, for insertion and for object adhesive affixing, then unscrewed from the object, to provide recessed object mounting threads that subsequently serve to secure a mounting screw inserted through the wall aperture from the wall front face. Many geometries of the single component injection molded implement are contemplated but include a thermoplastic shaft having a first end terminating in screw threads, a gripping or handle second end, an alignment disc attached directly to the first end thread portion, a flexible segment immediately adjacent to the alignment disc, and optional shaft threads between the flexible segment and the gripping second end. The implement terminal screw threads attach to an object by way of inner object threads. The implement may be disengaged from an attached object, for example, after adhesive bonding, simply by twisting the gripping end to uncouple, or unscrew the implement first end threads from the object.

In preferred embodiments the implement includes threads along the shaft major diameter to engage a threaded bushing or a nut to apply force during adhesive bonding. Prior to adhesive bonding, the center bore of the back plate is aligned such that plate bore threads, or other object threads are approximately concentric with a drilled wall aperture. Such alignment is advantageously enhanced with a disc segment immediately adjacent to the end threads of the tool. The disc segment possesses a larger diameter than either the flexible segment or end thread diameters. Following the disposition of an adhesive, such as a moisture curing adhesive, onto the inner surface adhesive wells of the attached back plate, and outboard of the plate center bore threads, the plate may be folded along the flexible segment so as to bring the object approximately parallel to the tool shaft, and then inserted through a wall aperture until the folded segment is clear to relax toward a transverse position. The object may then be pulled into firm contact with the rear wall surface using the gripping end of the tool. Firm contact may be prolonged and enhanced with tool geometries having external shaft threads, whose purpose is to engage a tensioning nut, or a bushing equipped with central bushing threads.

### Object Securing Means

Securing means are incorporated within the bore of the back plate or other object to engage mounting threads and the end threads of the thermoplastic mounting tool. Typically, the object or back plate includes primary bore threads, an affixed threaded nut, or a polymer insert to engage the threads of a mounting screw. Object bore threads are intended to engage the mounting threads of a fastener which is inserted from the front face of the wall. Other securing means include a hollow cylinder having inner threads to engage the mounting screw and hand tool, and outer surface adaptations to receive an adhesive. In the case of a back plate produced from a metal such as steel, a threaded insert similar to a conventional nut may be bonded to the outer surface of the back plate and concentric with the bore. For example, in the case of a nut, a recess may be machined or molded into the back plate to receive and adhere the nut using methods such as welding, crimping, gluing and the like. In such embodiments, when the back plate is inserted and adhesively affixed to the rear wall surface, the mounting screw may engage the bonded nut without the possibility of pulling the nut through the bore.

As described herein, the invention provides a method of mounting an object onto the front face of a hollow wall, the method comprising:
a) locating or drilling an aperture into a hollow wall,
b) selecting an object with central bore mounting threads, such as a back plate,
c) threadably attaching the polymeric hand tool first end threads to bore threads of a back plate,
d) depositing an adhesive upon the back plate in positions outboard of the plate central bore threads,
e) folding the attached plate within the flexible segment of the hand tool to bring the plate approximately parallel to the tool shaft body,
f) inserting the folded attached back plate through the wall aperture and into the hollow area of the wall while gripping the polymeric hand tool at second end,
g) permitting the attached plate to recover from its folded configuration to assume a transverse geometry relative to the tool body,
h) aligning the hand tool centering disc within the wall aperture, so as to locate the plate central bore threads coaxial to the wall aperture,
i) applying tension to the back plate or other object by pulling on the hand tool,
j) exerting tension upon the attached plate using the threaded shaft bushing or tensioning nut to urge the back plate inner surface into firm contact with the wall rear surface,
k) retaining tension during the adhesive bond time,
l) releasing tension exerted upon the back plate, and
m) disengaging the hand tool from the plate central threads by rotating the tool to provide a self-supported mounting device.
   The self-supported plate thereafter is available for receiving a mounting screw so as mount an object onto a hollow wall front surface.

The invention also pertains to a reusable tool or implement.
1. A reusable polymeric implement suitable for manipulating an object attached thereto, said implement comprising:
   a first distal end, said first end having a sizing disc and terminating with outer surface screw threads, said outer end threads equipped to engage and disengage the inner screw threads of an object;
   a second end, said second end adapted for hand gripping;
   a flexible segment positioned between said first and second ends, said flexible segment located immediately adjacent to said first end sizing disc; and
   a shaft located immediately adjacent to said flexible segment, the shaft having a major diameter;
wherein said flexible segment possesses a smaller cross-sectional area than said sizing disc and said shaft major diameter,
wherein said flexible segment permits acute to obtuse angle bending within said smaller cross-sectional area, and
wherein said flexible segment imparts sufficient elastic recovery to substantially recoil after said flexible segment bending.
2. The polymeric implement according to 1, further comprising male threads along the major shaft diameter, wherein said major diameter shaft threads are positioned between said implement flexible segment and implement second end.
3. The polymeric implement according to 2, wherein said major diameter shaft threads are equipped to engage a tensioning nut or bushing.
4. The polymeric implement according to 2, further comprising a bushing mounted on said shaft threads.
5. The polymeric implement according to 4, wherein the bushing is equipped with inner screw threads adapted to engage said major diameter shaft threads.
6. The polymeric implement according to 3 wherein said bushing or said tensioning nut may impart tension upon said first end when an object is threadably attached thereto.
7. The polymeric implement according to 1, wherein the implement is injection molded or additive manufactured, and wherein the polymeric implement material is selected from the group consisting of polyamide, polyolefin, polyester, and ABS.
8. The polymeric implement of 7, wherein said polyamide is nylon 6 or nylon 66.
9. The polymeric implement of 7, wherein said polyolefin comprises high density polyethylene.
10. The polymeric implement of 7, wherein said polyolefin comprises isotactic polypropylene.
11. The polymeric implement of 1, wherein said flexible segment is ribbon shaped.
12. The polymeric implement of 1, wherein said flexible segment is elliptic cylindrical shaped.
13. The polymeric implement of 1, wherein said flexible segment is cylindrical.

### Example 1

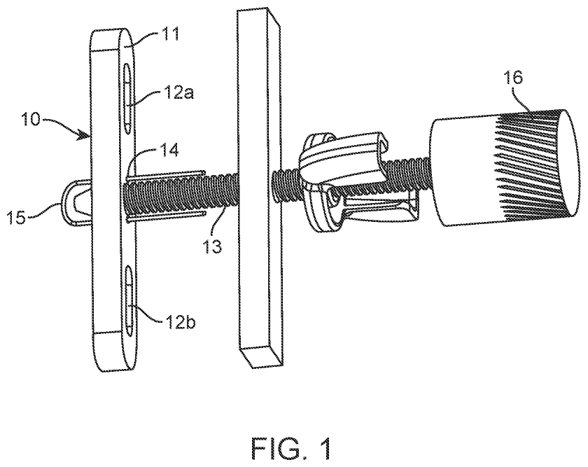

Referring to FIG. 1 of the drawings, a mounting device according to one embodiment of the present invention is depicted as a single member back plate 10, having a substantially planar inner contact surface 11, and having a fiber loop gripping means 15 and a primary bore with inner wall tapped threads to engage threads 13 on a tensioning tool equipped with knob 16. Plate 10 exhibits a greater length than width and greater length than thickness, so as to provide maximum surface contact with the rear face of the wall whilst maintaining minimal insertion hole diameter as a function of plate width and thickness. The back plate inner surface is shown with elliptical well depression adaptations, 12a and 12b to receive a dispensed measure of an adhesive. The fibrous lanyard 15 is depicted as having passed through at least one through-hole 14 adjacent to the primary bore, to grip plate 10, during the end-on insertion through a wall aperture. Plate 10 would be loaded with a deposit of adhesive along inner surfaces, as for example within wells 12a and 12b, such that the adhesive deposit is located away from, or outboard of the primary bore and primary bore inner cavity screw threads. The adhesive to be deposited into one or both well cavities is preferably an expanding moisture curing adhesive, such as offered by the Gorilla Glue Company, owing to its ability to expand, and thereafter spread outside of the cavity during the process of water reactive cure. Thus, in the example, one may dispense a measure of adhesive into the plate well while maintaining the threaded securing means unaffected during insertion, alignment, and curing of the bond between the inner device plate surface and the rear wall surface.

### Example 2

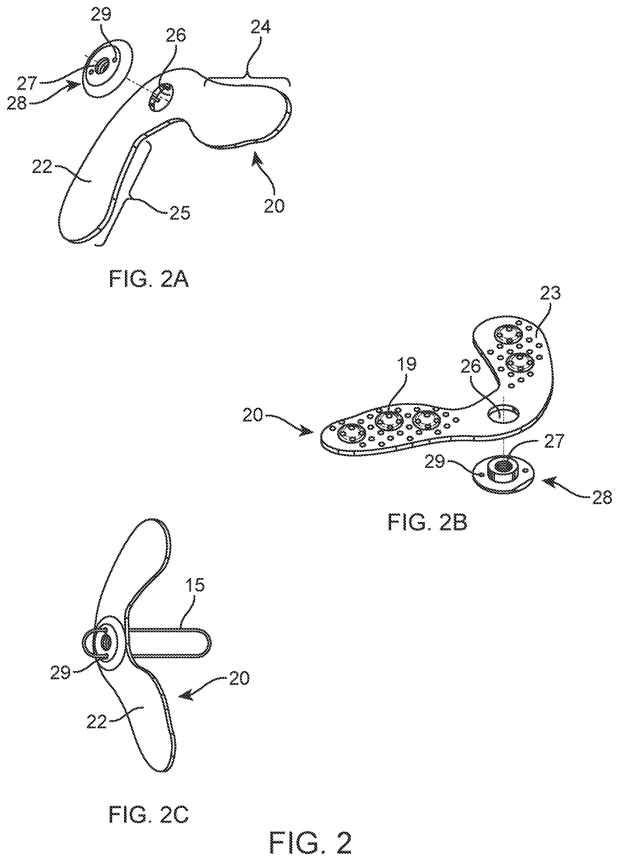

Example 2 illustrates another embodiment in accordance with the invention. FIGS. 2A, 2B, and 2C depict a device 20 for mounting an object onto the front surface of a hollow wall material including a single member, contiguous back plate having outer surface 22 and inner surface 23, as well as first and second lobed segments 24, 25 extending from primary bore 26. Inner plate surface 23 includes a plurality of hemispherical or cylindrical surface adaptions to receive and enhance the attachment of a deposit of adhesive. Plate inner surface adaptions are advantageously located along the first 24 and second 25 curvilinear segments, and outboard of the primary bore. Surface adaptations serve to visually direct the deposit of a measure of adhesive so as to not contaminate securing threads. Surface adaptions enhance adhesive retention during the step of installation, and later maximize surface bond strength. Threaded nut 28 is illustrated in the exploded diagrams 2A and 2B prior to pressing into bore cavity 26, to thereafter serve as a securing means to engage a mounting screw or a terminally threaded rod (not shown in figure) with female threads 27. Insert nut 28 includes at least one through hole 29 adjacent to tapped threads 27 for use as fiber lanyard grasping means. In alternate embodiments, surface adaptions within segments of plate 20 may include drilled apertures that penetrate to outer surface 22. An assembled mounting device is depicted in 2C as equipped with fiber lanyard grasping means 15, and ready to receive a deposit of adhesive 19 upon first and second segments of inner surface 23, and thereafter inserted through a hollow wall aperture to provide a recessed self-supported object mounting device.

### Example 3

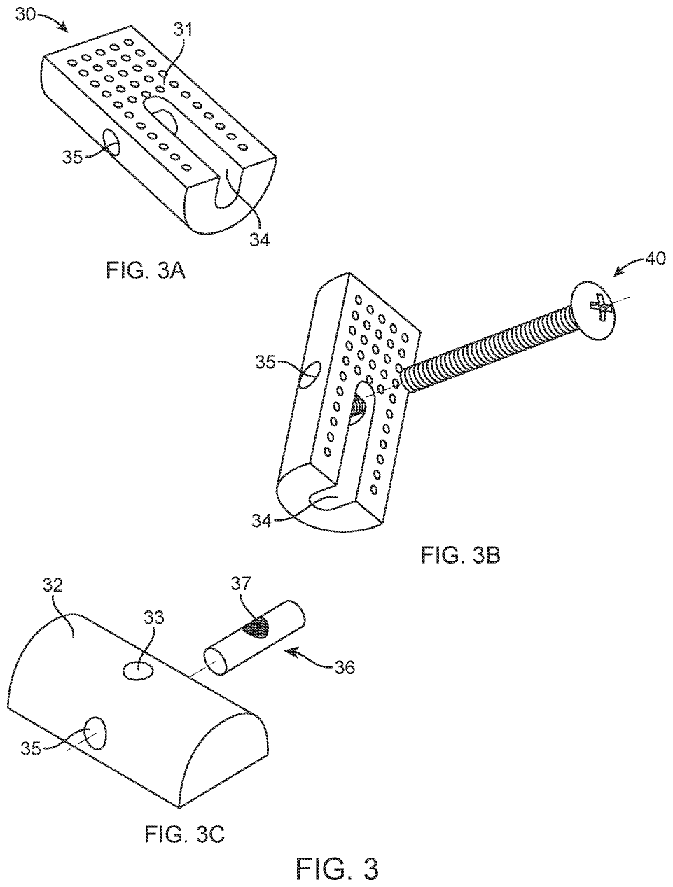

Referring to FIG. 3, the back plate 30 may be generally described as a solid aluminum longitudinally truncated semi-cylinder having a substantially planar and rectangular inner contact surface. Back plate 30 is herein depicted as having a substantially rectangular contact surface 31, a convex outer surface 32, a primary bore 33, a milled longitudinal channel 34, orthogonal secondary bore 35 and dowel 36. Back plate geometry may be obtained by longitudinally slicing a portion of the solid cylinder into two semi-cylinders, or in the case of a polymeric material, by injection molding to provide a longitudinally truncated cylinder. Dowel 36 includes a central bore that is equipped with female threads 37 to serve as securing means for a mounting screw such as 40. Threads within the dowel may be tapped directly into a dowel bore or alternatively may be attached to the dowel pin center and housed in a separate component equipped with female threads. When dowel 36 is installed into back plate orthogonal bore 35 it enables a mounting screw to engage dowel threads, so that when a mounting screw or a threaded rod 40 is threadably secured, the mounting screw or rod may pivot into channel 34 during the insertion of the device through a wall aperture. Prior to installing through the wall aperture, adhesive would be disposed along the hemispherical depressions provided on inner contact surface 31 to prepare the device for post insertion affixing onto the rear face of a hollow wall material. In Example 3, screw 40 performs both as grasping means during insertion, alignment, and bonding of an adhesive, and as a removable object mounting screw when back plate 30 is bonded to the hollow wall rear face and is self-supporting.

### Example 4

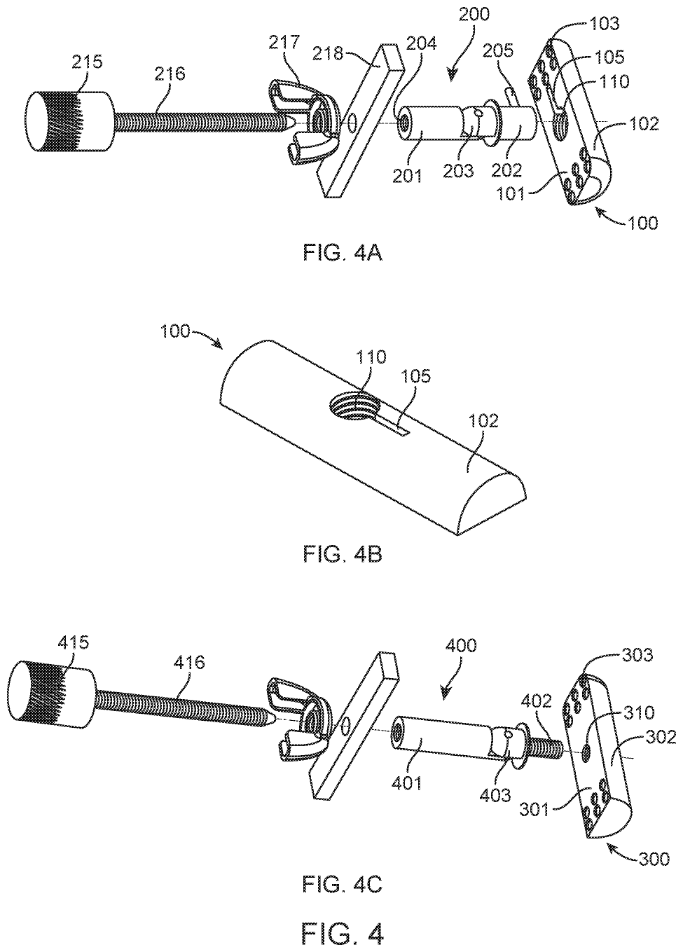

This example describes two means of grasping the back mounting plate that are within embodiments of the invention. Two metal pivoting grasping tool end types, or end effectors are hereafter described together with mating back plate bore geometries. Referring to exploded diagram FIG. 4A, back plate 100 is depicted as a single member, or contiguous semi-cylinder, with a substantially planar inner surface 101 and a convex outer surface 102. Plate 100 is equipped with threaded primary bore 110, adhesive retention surface adaptions 103, and twist key slot 105 communicating with back plate primary bore 110. Slot 105 includes a vertical milling for insertion and for twist engagement. Referring to drawing FIG. 4B, back plate 100 includes slot 105 and threaded bore 110 that are machined from inner surface 101 through rear outer surface 102, such that prong 205 of tool 200 may be pressed from inner surface 101 to emerge beyond surface 102 through slotted passage 105 and threaded bore 110 to thereafter twistably grip plate 100 along surface 102, whilst retaining threads in bore 110. In such embodiments, tool 200 may grasp plate 100, surface 101 would be provided with an adhesive, particularly in adaptions 103, then pivot at hinge 203 to permit profile reduction during end on insertion through a wall aperture. Following insertion through a wall aperture, back plate 100 would be pivoted again at 203 to resume a perpendicular conformation relative to tool 200. By use of tool 200, optionally extended by threaded rod 216, plate inner surface 101 would be urged into firm contact with a hollow wall rear surface to adhesively affix plate surface 101 along a rear hollow wall surface. After adhesive bonding between the rear wall surface and the inner plate surface, tool 200 would be twistably disengaged and withdrawn so that plate 110 would serve as a securing means for mounting objects. In alternate embodiments, primary bore 110 is equipped with a second interior circumferential bore slot, not illustrated, to twistably engage prong 205.

Grasping tool end 200 is now described. Grasping tool outer end 201 may be fixed to a simple handle or coupled to a hand tool by way of screw or hand tools that are designed for snap coupling to accept different end fittings. Tool 200 includes outer end 201 attached to a first end of a pivot hinge 203, and a key end 202 attached to a second end of pivot hinge 203. Key end 202 includes prong 205. In this illustration, outer tool end 201 includes a bore and tapped threads 204 that may be attached to hand tool knob 215, by way of threaded rod 216. When tool 200 is grasped using an attached handle, it would be pressed into twist slot 105 of plate 110 and then twisted to provide a disengageable means of grasping back plate 100. Optionally, wing nut 217 and bar 218 may be employed to provide front wall surface tensioning following plate insertion when a disposed adhesive along surface 101 is affixed. Once tool 200 is attached to back plate 100, adhesive would be deposited upon adapted surface areas 103 of plate inner surface 101. Once attached, the back plate may be pivoted about the metal hinge within 203 to permit end-on insertion of plate 100, through a predrilled aperture (not illustrated) in a hollow wall material. Following insertion into hollow wall cavity, the back plate may again be pivoted to return the engagement angle between tool 200 and plate 100 to assume a more perpendicular or transverse conformation. The back plate would be tensioned into firm contact with the rear surface of a wall material using handle knob 215 and held under tension until the adhesive deposit achieves self-supporting bond strength. Tool 200 is thereafter disengaged to reveal female threads within bore 110 of the self-supported back plate 100. Female threads tapped within the bore walls of the recessed affixed plate 100 are thereafter prepared to engage an object mounting screw when wishing to mount an object along the hollow wall front surface.

In FIG. 4C, back plate 300 is depicted as a single member, or contiguous semi-cylinder, with a substantially planar inner surface 301 and a convex outer surface 302. Inner surface 301 is equipped with primary bore 310 and surface adaptions 303 for adhesive retention. Primary bore 310 is equipped with female threads tapped into the walls of bore 310. Grasping tool 400 includes a handle end 401 attached to a first end of a pivot hinge 403, and threaded rod 402 attached to a second end of pivot hinge 403. In this illustration, outer handle end 401 will be attached to hand tool 415. When tool 400 is grasped using an attached handle, threaded rod 402 is turned to threadably attach plate 300 by securing with threads within 310. A measure of adhesive may be deposited onto the inner adaptation 303 outboard of tapped threads in bore 310. The back plate may be pivoted along pivot hinge 403 so as to provide a smaller profile to insert end on, and then pivoted about 90 degrees to present inner plate surface 301 to the rear wall surface for tensioning and affixing to the rear wall surface. After adhesive bonding, tool 400 is disengaged and withdrawn to provide a self-supported back plate 300, prepared to receive a mounting screw within threads of 310.

### Example 5

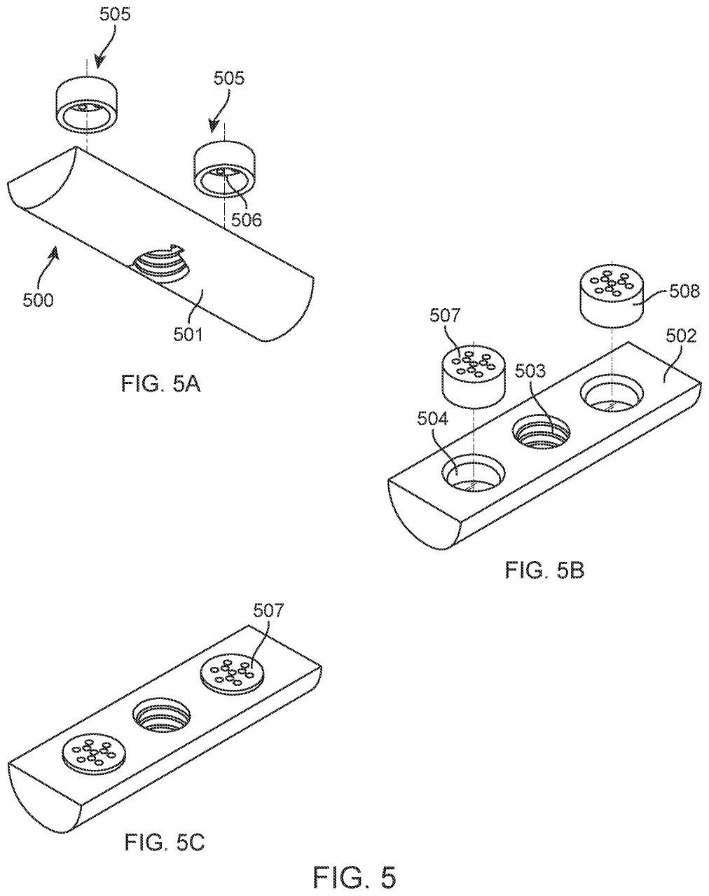

Referring to FIG. 5, back plate 500 is depicted as a longitudinally truncated half cylinder, having a planar rectangular contact surface 502, a convex outer surface 501, a primary bore with tapped threads 503, and second and third partially bored wells 504. Adhesive retaining cup-like capsules 505 include an internal cavity 506, and an outer surface 507. The capsules are equipped with perforations within the top outer surface, communicating with internal cavity 506. As depicted in the 5C, when cavity 506 of capsule 505 is loaded with a measure of adhesive, and when the capsule is inserted into plate cavities 504, the adhesive would be expressed through surface 507 perforations onto back plate inner surface 502 when urged into firm contact with a hollow wall rear surface, thereby affixing the back plate to the wall surface upon adhesive cure. The adhesive preferably includes a moisture reactive expanding polyurethane. In preferred embodiments, the capsule is produced from a resilient polymer, including polymers selected from the group consisting of a polyolefin, a nylon, a polyester, a styrenic, and PVC. The capsule wall height 508 is greater than plate well depth 504, to result in the inserted, adhesive-charged capsule presenting its perforated surface 507 raised above surface 502, thereafter, to express a contained adhesive payload through perforations when the back plate is urged into firm contact with the rear wall surface.

### Example 6

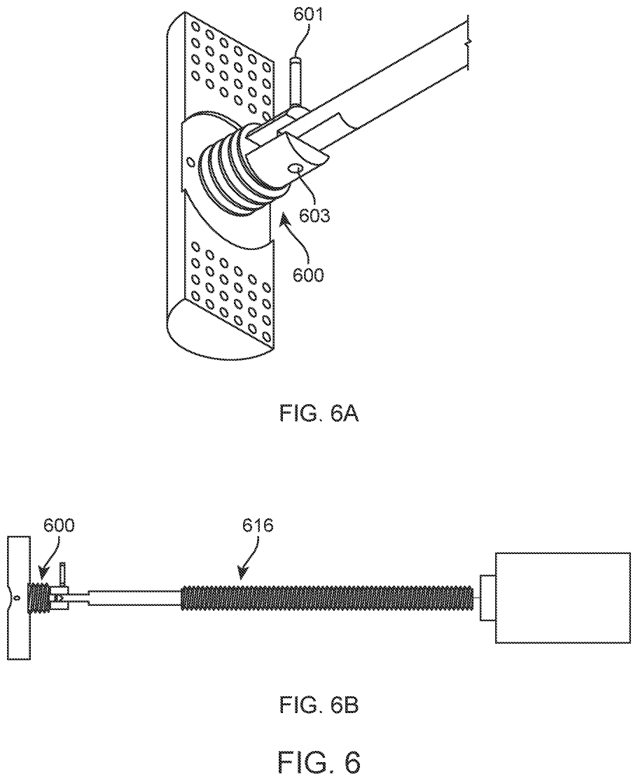

FIG. 6 depicts a method of engaging a grasping tool into the female primary bore threads, tapped within a back plate bore. FIG. 6 includes a perspective view and a side view of a hollow wall mounting device according to the invention. In the perspective view, the back plate primary bore is attached to the grasping tool terminal male threads. Grasping hand tool 600 is shown threadably engaged with the back plate. Tool 600 includes secondary bore 603 in the process of connecting shaft 616 and tensioning portion of the grasping end of the tool such that one may pivot about hinge pin 601. It is possible to change the back plate primary bore threads to accommodate a smaller gage fastener by inserting a double threaded reducing bushing into back plate primary bore threads. In this way the plate female threads may be adapted to receive smaller gage mounting screws by use of such a double threaded insert bushing. The reducing bushing is equipped with external threads matched to the threads of the primary bore of the back mounting plate, and internal threads selected to engage the threads of a mounting screw having threads of a different pitch or different caliber than those of the primary bore threads. In this example, one may affix the back plate to the inner wall surface and thereafter choose from a variety of mounting screws, by selecting and installing a double threaded sizing bushing insert to accommodate a desired mounting screw. Such sizing bushings are available from vendors such as McMaster-Carr. The use of a sizing bushing is particularly useful when changing exterior hardware. There are instances when one may wish to change the external appearance, such as changing a brass-colored mounting screw to a pewter colored screw. By use of the double tapped insert, one may readily change from a certain machine screw to a smaller diameter wood screw or a smaller diameter machine screw.

### Example 7

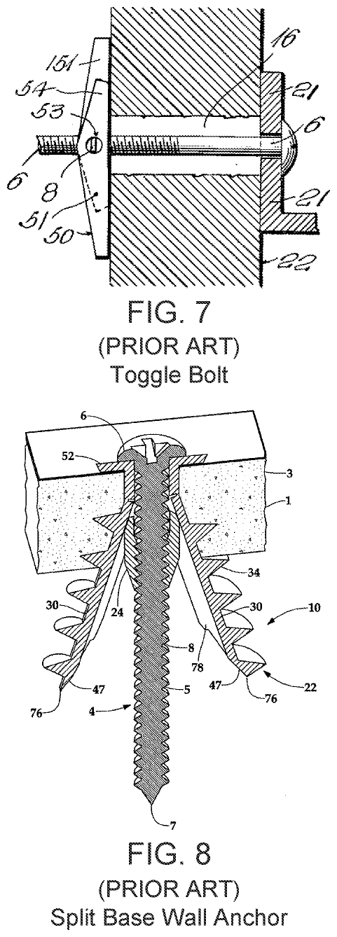

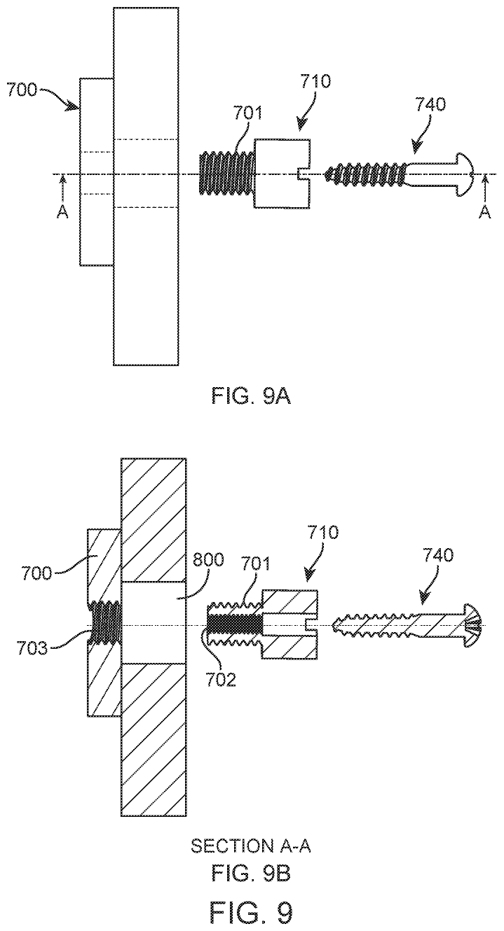

Referring to FIG. 7, U.S. Pat. No. 2,013,503, herein incorporated in its entirety by reference thereto, a prior art toggle is shown in side view, holding mounted object 21 through hollow wall aperture 16. This toggle bolt object mounting device of this comparative example includes the disadvantages of rear securing wings 50, 51 falling away behind the hollow wall when removing threaded bolt 6 from nut 8 if exchanging object 21, thereby precluding reuse of the assembly. The prior art has the additional disadvantage of utilizing folding U-shaped wings 50, 51 that present knife-like edges to a wall material. Such high pound per square inch contact pressure is prone to compressing or cutting into the paper skin of a material such as drywall.

### Example 8

The two parts of a steel mold are installed on the A and B sides of an injection molding machine. While the molds are being heated to the proper temperatures, such as between about 38° C. and 93° C., a thermoplastic resin, such as high density polyethylene, polypropylene, polyamide, polyester, is loaded into the hopper of the injection molding machine and advanced to the screw barrel for heating to the resin melting point, for example to about 240° C. to 290° C. One particularly useful resin is Vydyne® 21 SPF nylon 6,6 resin, available from Solution inc. 575 Manville Centre, St. Louis, MO., 63141.

Once all heating set points are reached, the mold is closed to a clamp pressure of 2 to 4tons per square inch and the injection of the thermoplastic is begun. Injection times are estimated to be about 1 second to 2.5 seconds. The mold is thereafter opened to release the injection molded reusable mounting tool.

One process that may be referred to for making the tools of the invention may be found in U.S. Pat. No. 3,009,220 to Fein, which is incorporated in its entirety by reference thereto.

### Example 9

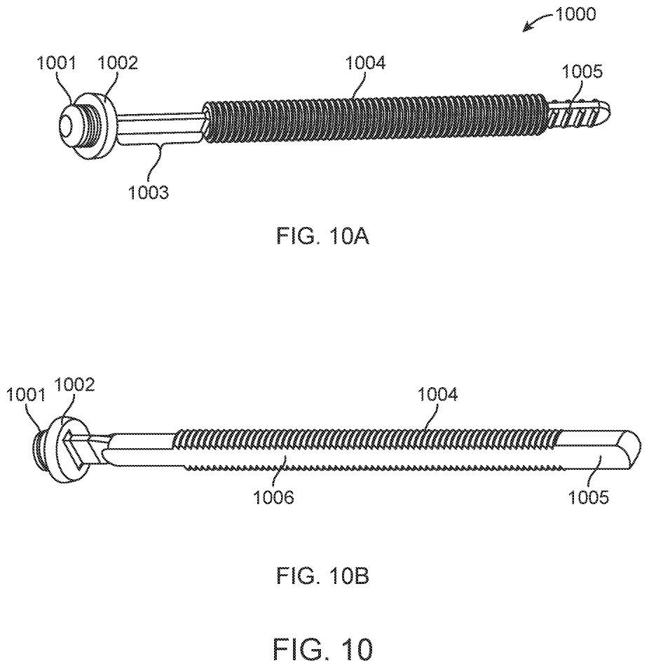

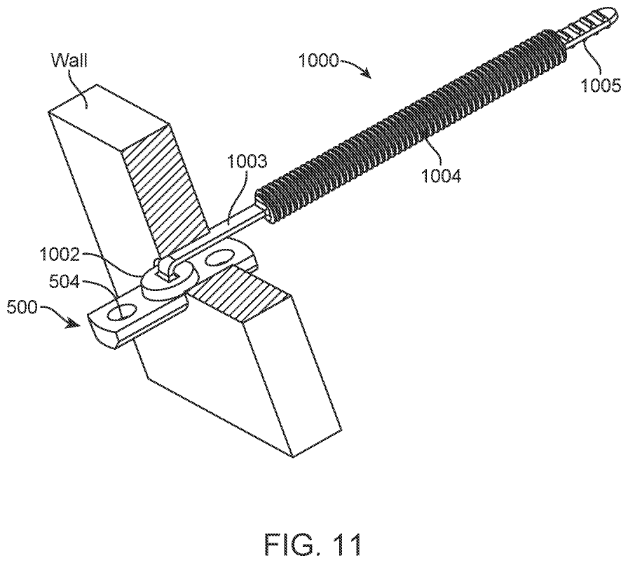

Referring to FIG. 5, a mounting plate is selected having central bore threads 503 and adhesive reservoirs 504. Referring to FIG. 10, end threads 1001 of tool 1000 are inserted into the central bore threads 503 of plate 500, and the tool is rotated to threadably secure plate 500 onto first end threads 1001. Plate 500 is equipped with adhesive retention cavities 504 outboard of attached central bore threads 503. A measure of moisture curable adhesive from Gorilla Glue is dispensed into wells 504, being careful to avoid the threads that temporarily attach the plate to the hand tool, while also avoiding the deposit of curing adhesive onto any portion of hand tool 1000, especially alignment disc 1002, immediately adjacent to first end threads 1001, flexible segment 1003, tensioning shaft threads 1004, and second gripping end 1005. As illustrated in FIG. 11, attached adhesive loaded back plate 500 is folded along flexible segment 1003 to an approximate bending angle of 90° such that the long axis of the plate becomes approximately parallel with the long axis of the polymeric hand tool for passage through a drilled hollow wall aperture. The hand tool is pressed forward to advance the attached plate completely through the drilled wall aperture such that the plate, the adjacent alignment disc and the flexible segment emerge into the hollow wall rear cavity.

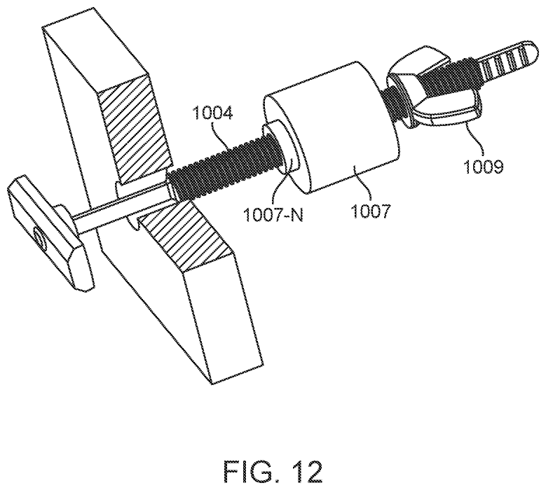

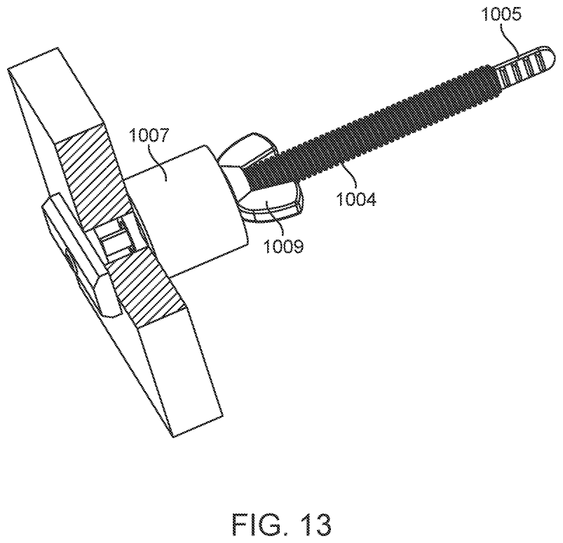

Turning to cutaway FIG. 12, the advantageous elastic recovery of the flexible segment of the thermoplastic hand tool assists the attached mounting plate to recover from its folded conformation to again assume an earlier transverse or “T” shaped conformation. Referring to FIG. 13, an operator grips either the second end gripping segment 1005, or the shaft, to pull the plate toward the rear surface of the wall board, such that the flexible segment 1003 and the alignment disc 1002 are thereafter housed within the drilled wall cavity. Disc 1002 is engineered with a lesser diameter than the drilled aperture so that it rotates freely within the drilled aperture, but yet can inform the operator that the two adhesive wells are in contact, and the engaged plate bore threads are coaxial with the wall aperture.

Referring to FIGS. 12 and 13, tensioning nut 1009 is advanced along implement shaft threads 1004 to press bushing 1007 into contact with the front wall face. Bushing nose 1007-N is guided into the wall aperture, and nut 1009 is firmly tightened. The operator may then release their hold on the hand tool to permit time for the adhesive to cure.

The operator later returns and releases applied tension by reversing tensioning nut 1009 such that the bushing no longer presses firmly against the front wall surface. The operator thereafter spins the hand tool to disengage first end threads 1001 from bore threads 503 and retracts the tool from the aperture. The recessed plate remains adhesively affixed to the rear wall surface and self-supported to receive a mounting screw. The hand tool may be reused for another installation.

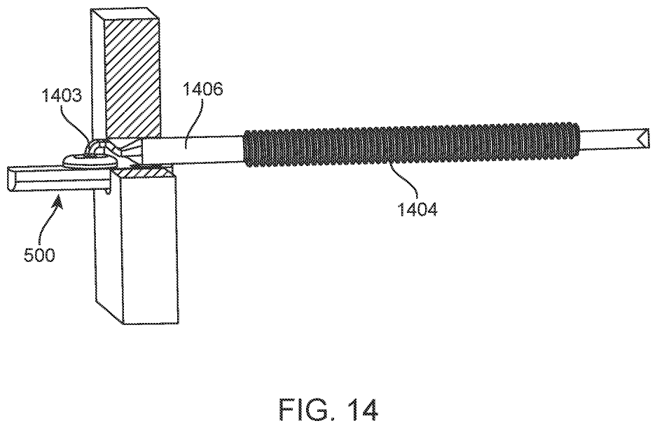

Referring to FIG. 14, the cutaway illustrates an embodiment of the polymeric hand tool equipped with a minor diameter flexible segment 1403 attached to unthreaded shaft portion 1406, that adjoins threaded shaft segment 1404. In this illustration, the flexible segment is substantially smaller in cross-section than the implement shaft. For example, the flexible segment may be 50% of the shaft diameter, or may be 40% of the shaft diameter, or may be 30% of the shaft diameter, of may be 20% of the shaft diameter. The substantially smaller diameter of the flexible segment may thereby bend to an angle of 90 degrees, but may bend to an angle of, for example, 180 degrees to permit loading an attached plate through a wall aperture. In the example depicted as FIG. 14, the flexible segment assumes a crook or hook shape as the object is pressed through the wall aperture.

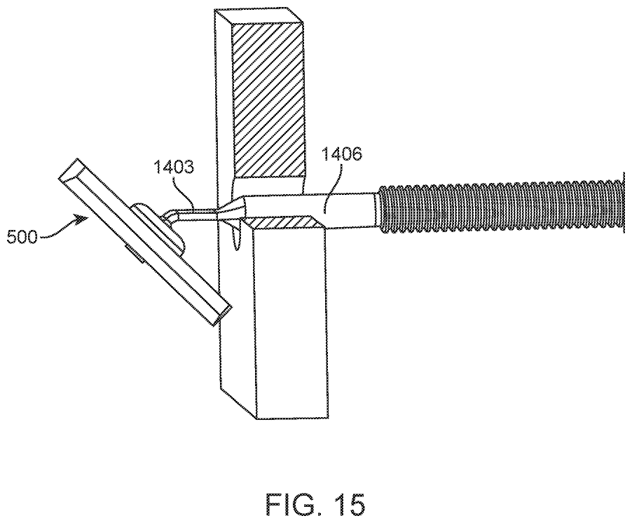

Referring to FIG. 15, object 500 conveniently recovers from the crooked bend depicted in FIG. 14 aided by the resiliency of the polymeric implement material and will subsequently be pulled to bring object 500 into firm contact with the rear wall surface.

Having described the invention through drawings and examples, it should be recognized that modifications and variations to exemplar embodiments herein disclosed will be understood by those having skill in the art. Specific examples are illustrative rather than representing any limitations or the invention. The scope of the present invention is limited only by the appended claims.

We claim:

1. A reusable polymeric implement suitable for manipulating an object attached thereto, said implement comprising:
a first end, said first end terminating with male threads, said threads equipped to engage the female threads of an object;
a second end, said second end adapted for hand gripping;
a rod-like section defining a shaft segment, said shaft positioned between said first and second ends; and
a flexible segment, said flexible segment located immediately adjacent to said first end, and between said first end and said shaft;
wherein said flexible segment of said polymeric implement permits resilient bending within said flexible segment to permit said first end to move an attached object into alignment with said shaft,
and wherein said flexible segment imparts sufficient resilience to recoil after such bending, when manipulating an object threadably attached thereto.

2. The polymeric implement according to claim 1, further comprising a centering disc immediately adjacent the first end threads and located between said end threads and said flexible segment.

3. The polymeric implement according to claim 1, further comprising male threads on said shaft segment, positioned between said flexible segment and said second end to define shaft threads.

4. The polymeric implement according to claim 3, wherein said shaft threads are engineered to receive and engage a tensioning nut.

5. The polymeric implement according to claim 3, further comprising a bushing.

6. The polymeric implement according to claim 4 wherein said tensioning nut may impart tension upon said first end when an object is threadably attached thereto.

7. The polymeric implement according to claim 5, wherein the bushing is equipped with inner screw threads adapted to engage shaft threads and thereby impart tension upon said first end.

8. The polymeric implement according to claim 1, wherein the polymer is selected from the group consisting of polyamide, polyester, polypropylene, high density polyethylene, and ABS.

9. The polymeric implement of claim 7, wherein said polyamide is nylon 6 or nylon 66.

10. The polymeric implement of claim 1, wherein said flexible segment is ribbon shaped.

11. The polymeric implement according to claim 1, wherein said flexible segment has a cylindrical geometry and wherein said flexible segment exhibits a smaller diameter than that of the aligning disc and that of the shaft threads.
